(19) United States
(12) Patent Application Publication
(10) Pub. No.: US 2014/0028867 A1
(43) Pub. Date: Jan. 30, 2014

(54) Illuminating Device for Close-up Photographing

(71) Applicant: Douglas Alan Erickson, Merrimac, MA (US)

(72) Inventor: Douglas Alan Erickson, Merrimac, MA (US)

(21) Appl. No.: 13/558,311

(22) Filed: Jul. 25, 2012

(51) Int. Cl. H04N 5/225; H04N 5/232; G03B 15/02; G03B 13/32; G03B 15/03

(52) U.S. Cl. CPC H04N 5/225; G03B 13/32; G03B 15/03; G03B 15/02; H04N 5/23293
USPC 348/222.1; 396/106; 362/8; 348/333.01

(57) ABSTRACT

A mobile photographic accessory that simultaneously stabilizes a recording camera, illuminates the subject, and provides an optional close-up lens, thus enhancing close-up photographs and video recordings.

### CROSS-REFERENCE TO RELATED APPLICATIONS

| Cited Patent | Filing date | Issue date | Original Assignee | Title |
|---|---|---|---|---|
| U.S. Pat. No. 3,810,209 | Oct. 30, 1972 | 1974 | | CAMERA |
| | | | | POSITIONING |
| | | | | APPARATUS |
| U.S. Pat. No. 3,906,520 | Aug. 3, 1973 | Sep. 1, 1975 | | APPARATUS FOR |
| | | | | PRODUCING A HIGH |
| | | | | CONTRAST VISIBLE |
| | | | | IMAGE FROM |
| | | | | AN OBJECT |
| U.S. Pat. No. 4,310,231 | Oct. 14, 1979 | Jan. 12, 1982 | Canon | CLOSE-UP COPY |
| | | | Kabushiki Kaisha | APARATUS |
| U.S. Pat. No. 5,825,502 | Oct. 9, 1996 | Oct. 20, 1998 | Rolf Myer | DEVICE |
| | | | | FOR CLOSE-UP |
| | | | | PHOTOGRAPHY OF |
| | | | | SURFACES |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of photography. More particularly, the present invention is in the technical field of close-up photographic lighting devices.

Conventional close-up photographic devices, such as macro lenses, close-up lens attachments and the like, typically rely on separate lighting systems. Such lighting systems typically create shapes visible in reflective surfaces being photographed. Eliminating these shapes typically requires re-touching of the captured image(s). The difficulties of eliminating such shapes are multiplied when photographing multi-faceted surfaces such as gems. Further, it is not an uncommon experience to realize that the post-photographic re-touching of such images results in artificial image elements. Further, traditional close-up lenses such as macro lenses, close-up lens attachments and the like, and lighting attachments, such as ring flashes and the like, typically fit only one brand or size of camera and lens, or require a special mounting adapter to be used with various cameras and lenses.

### SUMMARY OF THE INVENTION

The present invention is a photographic lighting device for photographing close-up photographic images, having an integral magnifying lens and an enclosure eliminating additional shadows and reflected photographic elements. By allowing the camera to rest on a protective pad covering the enclosure, the need for lens-specific mounting hardware is eliminated.

### BRIEF DESCRIPTION OF THE DRAWING

FIG. 1 is a perspective view of an illuminating device for close-up photographing of the present invention;

FIG. 2 is an underside view of an illuminating device for close-up photographing of FIG. 1;

FIG. 3 is an exploded view of an illuminating device for close-up photographing of FIG. 1.

### DETAILED DESCRIPTION OF THE INVENTION

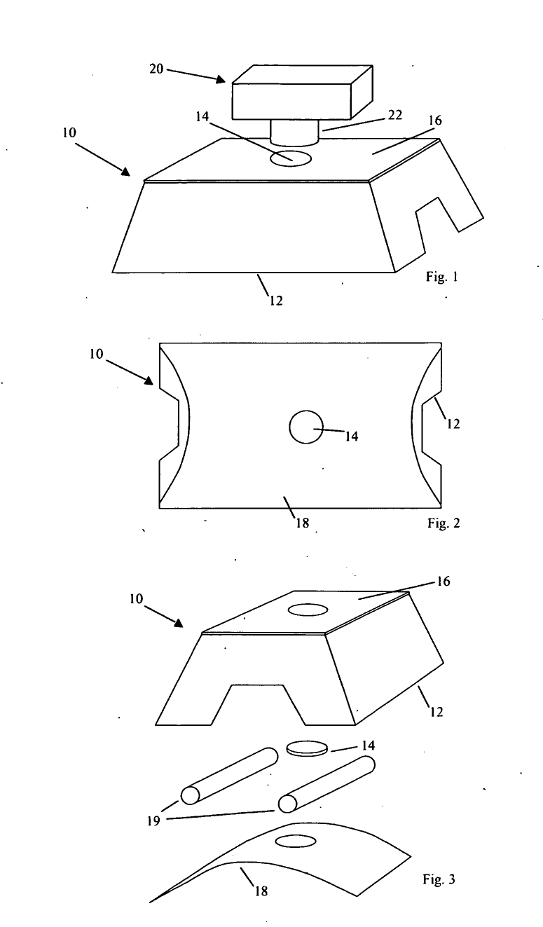

Referring now to the invention in more detail, in FIG. 1 there is shown an illuminating device for close-up photographing 10 having an opaque body 12 that incorporates a magnifying lens 14 near or proximate the center of the body 12.

In further detail, still referring to the invention of FIG. 1, the pad 16 allows the lens 22 of camera 20 to rest directly on top of the opaque body 12 without necessitating additional mounting hardware while protecting lens 22 from scratches or abrasions typically resulting from contact with hard surfaces.

In further detail, still referring to the invention of FIG. 1, the opaque body 12 may include openings on one or more sides to allow long objects such as a sword, a human arm with a wristwatch, or the like to fit beneath it.

Referring now to FIG. 2 there is shown an illuminating device for close-up photographing 10 having an opaque body 12 that incorporates a magnifying lens 14 near or proximate the center of the opaque body 12. A sheet of semi-opaque material 18 diffuses light emitted by the illuminating device for close-up photographing 10.

Referring now to FIG. 3, there is shown an exploded view of an illuminating device for close-up photographing 10, with pad 16, opaque body 12, magnifying lens 14, light source 19, and diffusion screen 18.

In further detail, still referring to the invention of FIG. 1, FIG. 2 and FIG. 3, the opaque body 12 is sufficiently wide and long to cover a small object such as a piece of jewelry, a coin, or the like, such as about 8 to 12 inches deep and about 12 to about 18 inches wide. The opaque body 12 is sufficiently tall to cover a small object such as a piece of jewelry, a watch, a coin or the like, allowing sufficient clearance for the magnifying lens 14, light source 19 and diffusion screen 18, such as about 6 to 10 inches off the ground.

The construction details of the invention as shown in FIG. 1 and FIG. 2 and FIG. 3 are that the opaque body 12 may be made of plastic, wood or of any other sufficiently rigid and strong material such as metal, and the like. Further, the inside of opaque body 12 may be finished with a reflective color such as white, silver, gold or the like to maximize brightness. Further, the magnifying lens 14 may be made of sufficiently clear material such as glass, plastic and the like. Further, the pad 16 may be made of any soft material such as leather, rubber and the like. Further, the diffusion screen 18 may be made of any sufficiently translucent material such as paper, plastic, cloth and the like.

In further detail, the construction details of the invention as shown in FIG. 3 are that the light source 19 may be powered either with alternating or direct current. Light source 19 may incorporate light bulbs such as fluorescent, tungsten, quartz halogen or the like. Light source 19 may be stroboscopic or constant. Magnifying lens 14 may be permanently fixed, manually removable, or mechanically positioned, such as by a hinge, threaded axel or the like.

The advantages of the present invention include, without limitation, that it is compatible with a wide variety of photographic devices without the need for any additional mounting hardware. Further, it creates diffuse light in relation to small objects being photographed, eliminating undesirable photographic elements such as shadows and reflections.

In broad embodiment, the present invention is a lighting device that incorporates an optional magnifying lens in an opaque box of sufficient size to surround a small object with light.

1. An illuminating device for close-up photographing, comprising:
(a) a camera-stabilizing, rigid enclosure;
(b) a diffused light source mounted in said enclosure, and;
(c) a moveable lens mounted in said enclosure;
whereby said device can be used to light and magnify an object in proximity to a stabilized photographic recording device resting thereon.

2. The illuminating device according to claim 1, wherein a photographic recording device is integrated in the rigid enclosure

3. System for digital image recording of an object comprising a device according to claim 2, further comprising means for displaying, selecting and storing of images or sequences of images.

4. System for digital image recording of an object according to claim 3, further comprising one or more of the following tools: tools for comparing, modifying and analyzing the images, means for adding text information to the image datasets, tools for adding sound information to the image datasets, tools for managing the image datasets and related datasets in a database system, and means for producing output from the image- and related datasets.

5. Method for digital recording of an object using a system according to claim 3, comprising the selection of an image or image sequence by a trigger, the display of the images on a monitor and the storage of the images.

6. Method for digital recording of an object according to claim 3, comprising one or more of the following procedures: a recorded image is modified and analyzed, text is added and stored in relation with the image dataset, sound is added and stored in relation with the image dataset, the datasets containing the image and related information are stored and managed in a database system, individual “archive” images are displayed together with the recorded “live” image or other archive images for comparison, output of images and related information is produced.
